(19) United States
(12) Patent Application Publication
(10) Pub. No.: US 2012/0057918 A1
(43) Pub. Date: Mar. 8, 2012

(54) CUTTER MECHANISM AND PRINTER INCLUDING THE SAME

(75) Inventor: Kenji EOKA, Shizuoka (JP)

(73) Assignee: TOSHIBA TEC KABUSHIKI KAISHA, Tokyo (JP)

(21) Appl. No.: 13/217,762

(22) Filed: Aug. 25, 2011

(30) Foreign Application Priority Data
Sep. 3, 2010 (JP) 2010-197936

(51) Int. Cl. B41J 11/66; B26D 5/06

(52) U.S. Cl. 400/621; 83/563

(57) ABSTRACT

A cutter mechanism for use in a printer includes a main body unit to rotatably hold a thermal head by means of a spring which biases the thermal head against a platen provided in an opening/closing unit rotatably fixed to the main body unit, and a print medium conveyance path interposed between the thermal head and the platen. The cutter mechanism further includes a fixed blade unit with a fixed blade, attached to the main body unit, and a movable blade unit with a movable blade, attached to the opening/closing unit. The movable blade cuts a print medium in cooperation with the fixed blade. The fixed blade and the movable blade move to a fixed blade OPEN state position and a movable blade OPEN state position, respectively, away from the print medium conveyance path when the opening/closing unit is in an OPEN state.

### CROSS-REFERENCE TO RELATED APPLICATION

This application is based upon and claims the benefit of priority from Japanese Patent Application No. 2010-197936, filed on Sep. 3, 2010, the entire contents of which are incorporated herein by reference.

### FIELD

Embodiments described herein relate generally to a cutter mechanism and a printer including the cutter mechanism.

### BACKGROUND

A printer for printing on a print medium such as a paper roll includes a cutter mechanism to cut the print medium, once it is printed on, to an appropriate length. For example, a guillotine cutter mechanism may be employed as such a cutter mechanism.

A guillotine cutter mechanism uses a cutter unit having a fixed blade and a movable blade, which are integrated with each other and arranged in a printer such that a print medium conveyance path is interposed between the fixed blade and the movable blade. In general, the guillotine cutter mechanism may jam when paper from the paper roll is not completely cut off from the paper roll and gets stuck between the fixed blade and the movable blade. To address this type of paper-jam, the printer includes units separable from each other into a platen side and a print head side. One of the units is operable to switch between an open state and a closed state, and the cutter unit is attached to such openable unit.

However, in such a printer, when a jam error is resolved and the printer is closed without performing any further operation, paper from the paper roll may still be stuck between the cutter unit and the openable unit. To resolve such problem, prior to closing the printer, another operation is required to allow paper from the paper roll to pass between the fixed blade and the movable blade and return to its original state. In addition, a user may be in danger of making contact with the movable blade or the fixed blade while trying to resolve the paper jam error.

### BRIEF DESCRIPTION OF THE DRAWINGS

FIG. 1 is a schematic perspective view showing a configuration of a printer including a cutter mechanism according to one embodiment.

FIG. 2 is a schematic sectional view showing an OPEN state of the printer including the cutter mechanism.

FIG. 3 is a schematic sectional view showing a CLOSED state of the printer including the cutter mechanism.

FIG. 4 is an exploded perspective view showing a movable blade unit and a fixed blade unit in the cutter mechanism.

FIGS. 5A to 5C are sectional views showing a transition from an OPEN state to a CLOSED state of the movable blade and the fixed blade in the cutter mechanism.

### DETAILED DESCRIPTION

According to one embodiment, a cutter mechanism includes a fixed blade unit having a fixed blade. The fixed blade unit is attached to a first portion of a printer. The printer has an OPEN state and a CLOSED state. The cutter mechanism further includes a movable blade unit including a movable blade. The movable blade unit is attached to a second portion of the printer. The second portion of the printer is positioned such that a print medium conveyance path passes between the first portion and the second portion. The movable blade is configured so that it moves along the fixed blade to cut a print medium when the printer is in the CLOSED state. When the printer is in an OPEN state, the fixed blade and the movable blade are configured to move to a fixed blade OPEN state position and a movable blade OPEN state position, respectively, away from the print medium conveyance path.

Embodiments will now be described in detail with reference to the drawings. In the following description and the drawings, like reference numerals refer to the same or similar configurations and functions.

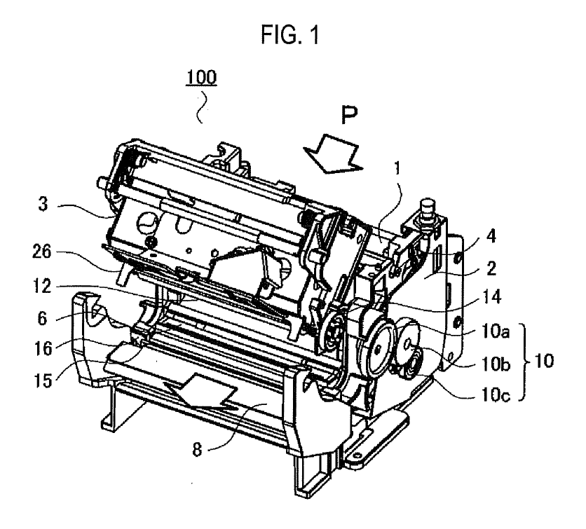

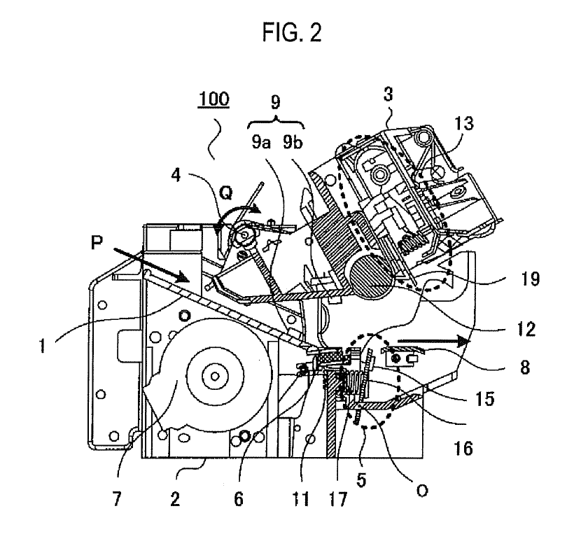

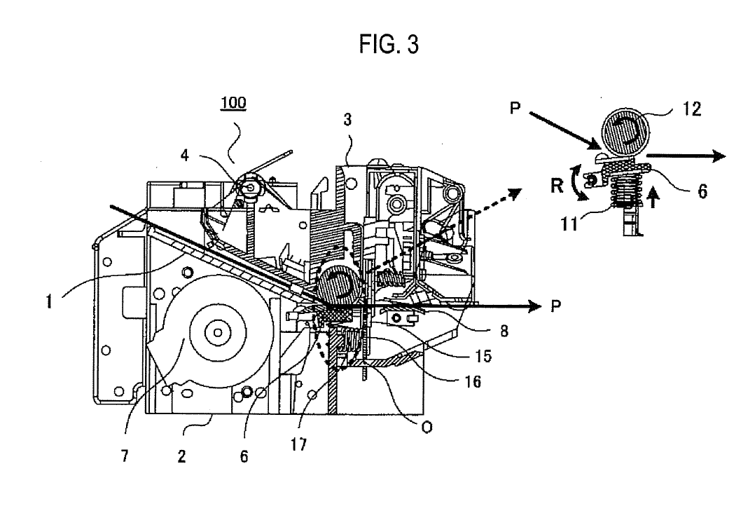

First, a configuration of a printer including a guillotine cutter mechanism according to one embodiment of the present disclosure will be described in detail with reference to FIGS. 1 to 3. FIG. 1 is a schematic perspective view showing a configuration of a printer 100 including a guillotine cutter mechanism according to one embodiment. FIGS. 2 and 3 are schematic sectional views of the printer 100. FIG. 2 shows an OPEN state of the printer 100, and FIG. 3 shows a CLOSED state thereof. As shown in FIGS. 1 to 3, the printer 100 includes a main body unit 2 and an opening/closing unit 3 which are separable from each other along a print medium conveyance path 1 through which a print medium P such as thermal paper is conveyed. The opening/closing unit 3 is rotatably (in a direction as indicated by a bidirectional arrow Q) attached to the main body unit 2 via a shaft 4. In the OPEN state as shown in FIG. 2, the opening/closing unit 3 is moved upward (i.e., in a direction away from the main body unit 2) by rotating along the shaft 4. On the other hand, in the CLOSED state as shown in FIG. 3, the opening/closing unit 3 is moved downward (i.e., in a direction toward the main body unit 2) by rotating along the shaft 4, such that a platen 12 arranged in the opening/closing unit 3 contacts a thermal head 6 arranged in the main body unit 2 (which will be described later). In addition, the opening/closing unit may be configured to be biased in an OPEN direction (e.g., a clock-wise direction indicate by the arrow Q in FIG. 2) by a torsion coil spring or the like.

The main body unit 2 includes a fixed blade unit 5, the thermal head 6 configured to print on the print medium P, a print medium conveying motor 7 configured to convey the print medium P, a paper guide 8, an OPEN/CLOSED sensor 9 configured to detect an OPEN/CLOSED state of the opening/closing unit 3, and a driving gear train 10 configured to transmit a driving force from the print medium conveying motor 7 (see FIGS. 2 and 3). The thermal head 6 is biased against the platen 12 by a biasing spring 11 and is rotatably (indicated by an arrow R) supported by the main body unit 2.

The OPEN/CLOSED sensor 9 includes a sensor 9a and a projection piece 9b. The projection piece 9b is arranged in the opening/closing unit 3 to face the sensor 9a arranged in the main body unit 2, such that the projection piece 9b contacts the sensor 9a in the CLOSED state. The OPEN/CLOSED sensor 9 detects the CLOSED state as the sensor 9a contacts the projection piece 9b. In an alternate embodiment, the sensor 9a and the projection piece 9b may be configured to face each other at the opposite positions to the manner as described above. Specifically, the sensor 9a is arranged in the main body unit 2 to face the projection piece 9b arranged in the opening/closing unit 3, such that the projection piece 9b contacts the sensor 9a in the CLOSED state.

The opening/closing unit 3 includes the platen 12 and a movable blade unit 13. The platen 12 is arranged to face the thermal head 6 in the CLOSED state. In addition, the platen 12 is connected to a driving gear 14 (see FIG. 1) so that the print medium conveying motor 7 can transfer a driving force to the platen 12 via the driving gear 14, thereby rotating the platen 12 at a conveyance speed corresponding to a print speed of the thermal head 6.

As shown in FIG. 3, the print medium P is introduced from a print medium supply unit (not shown) into the print medium conveyance path 1 when the opening/closing unit 2 is in the CLOSED state. Further, the print medium P is pressed by a predetermined pressure when it passes between the thermal head 6 and the platen 12. The print medium P is printed by the thermal head 6 while being interposed between the thermal head 6 and the platen 12. The printed print medium P is then conveyed further up to a predetermined position downstream of the print medium conveyance path 1, and cut by a cutter. The cut print medium P is discharged along the paper guide 8.

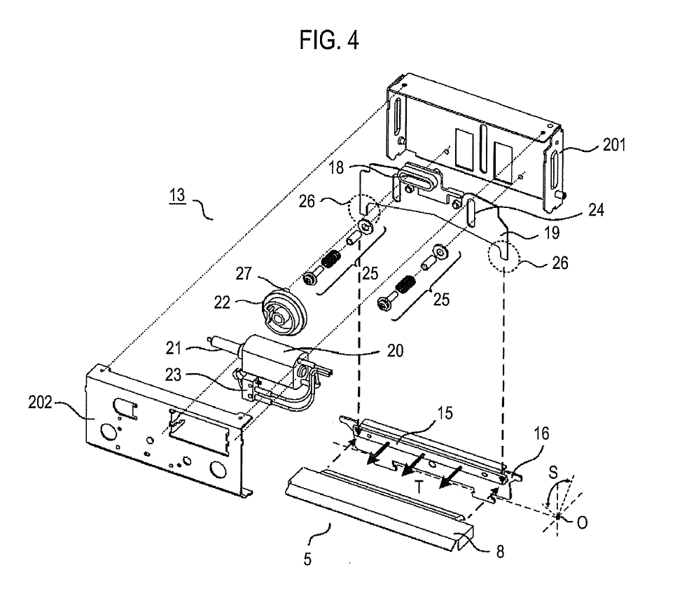

The following is a description of the fixed blade unit 5 and the movable blade unit 13 with reference to FIG. 4. FIG. 4 is an exploded perspective view showing the fixed blade unit 5 and the movable blade unit 13. The fixed blade unit 5 includes a fixed blade 15, a fixed blade stay 16 configured to fix the fixed blade 15 thereon, and a fixed blade biasing spring 17 (see FIGS. 2 and 3). The fixed blade 15 is fixed to the fixed blade stay 16 by means of, for example, a spot welding or the like. The fixed blade stay 16 is rotatably (in a direction as indicated by a bidirectional arrow S) attached to the main body unit 2 via a shaft O and is biased by the fixed blade biasing spring 17 in a direction indicated by an arrow T. Accordingly, in the OPEN state, the fixed blade 15 is inclined toward the paper guide 8, thereby preventing a user from making contact with the fixed blade 15.

The movable blade unit 13 has a rectangular box-shaped housing, which is configured by engaging a side-opened base frame 201 with a cutter motor frame 202 serving to cover an open side of the base frame 201. The movable blade unit 13 with the above configuration is mounted in the opening/closing unit 3. The base frame 201 is provided with a movable blade on which a cutter link 18 is mounted. Further, the cutter motor frame 202 is provided with a cutter motor 20 configured to drive the movement of the movable blade 19, a worm gear 21, a worm wheel 22, and a movable blade position detecting sensor 23 configured to detect a position of the movable blade 19.

The movable blade 19 has a guide groove 24 and is slidably supported by the base frame 201 through a supporting means 25 such as a screw with an elastic member such as a coil spring interposed therebetween. In the above configuration, the supporting means 25 is slidably inserted into the guide groove 24. In addition, both ends of the movable blade 19 are provided with projection guides 26 extending downward therefrom, which serve as guides to guide the movement of the movable blade 19 when it is in contact with fixed blade 15.

The cutter motor 20 is connected to the worm gear 21 and is fixed to the cutter motor frame 202. The worm wheel 22 is arranged to engage with the worm gear 21. A stud 27 is press-fitted in the worm wheel 22 at a position eccentric from a rotational center of the worm wheel 22, and configured to engage with the cutter link 18. With this configuration, the rotation of the cutter motor 20 drives the rotation of the worm wheel 22, which in turn drives the movable blade 19 to be vertically moved along the guide groove 24. In the CLOSED state, the movable blade 19 is held at such a position that a space (or opening) through which the print medium P can pass is formed between the movable blade 19 and the fixed blade 15 (hereinafter also referred to as a “start position”).

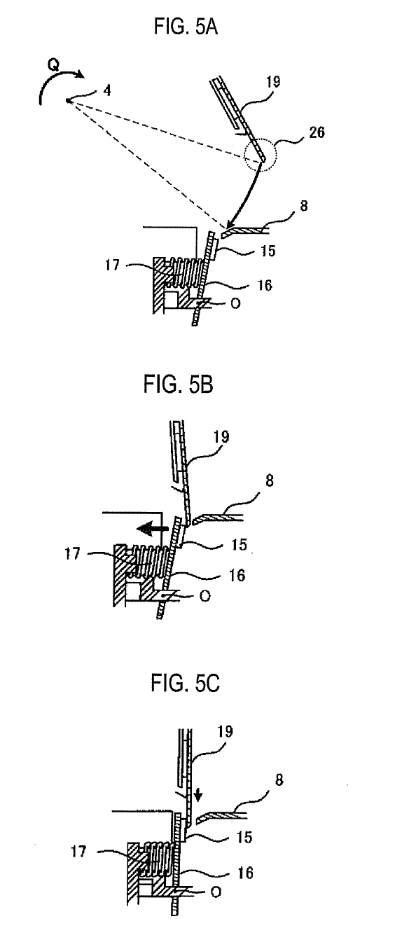

Operation of the fixed blade and the movable blade according to this embodiment will be described with reference to FIGS. 5A to 5C. FIGS. 5A to 5C are views showing a main configuration for explaining operation of the fixed blade 15 and the movable blade 19 as shown in FIG. 2.

As shown in FIG. 5A, in the OPEN state, as the fixed blade stay 16 is biased by the fixed blade biasing spring 17, the fixed blade 15 is inclined toward the paper guide 8 such that it retreats to a position, e.g., at which it may not contact a user's hands (hereinafter referred to as a “fixed blade OPEN state position” or “retreat position”). On the other hand, the movable blade 19 stays at a position at which only the guide 26 is exposed outside of the movable blade unit 13 (hereinafter referred to as a “movable blade OPEN state position” or “retreat position”). In this state, similar to the fixed blade 15 as described above, a blade portion of the movable blade 19 retreats to a position at which it may not contact a user's hands, that is, inside the movable blade unit 13. In an alternate embodiment, a separate member configured to cover the blade portion of the movable blade 19 may be provided without placing the movable blade 19 in the retreat position.

If the opening/closing unit 3 in the OPEN state shown in FIG. 5A is moved downward, the movable blade 19 approaches the fixed blade 15 in such a manner that the movable blade 19 is inserted between the paper guide 8 and the fixed blade stay 16 while rotating around the shaft 4 of the opening/closing unit 3. Thereafter, as shown in FIG. 5B, as the guide 26 of the movable blade 19 contacts the fixed blade 15 to thereby place the opening/closing unit 3 almost in the CLOSED state, the fixed blade 15 is pressed by the guide 26 against a biasing force by the fixed blade pressing spring 16 and is moved away from the paper guide 8. As shown in FIG. 5C, in the CLOSED state, the OPEN/CLOSED sensor 9 detects the CLOSED state of the opening/closing unit 3 and drives the cutter motor 20 so that the movable blade 19 moves from the retreat position to the start position. In the CLOSED state, the fixed blade 15 is biased against the movable blade 19 by means of the fixed blade biasing spring 17 via the fixed blade stay 16, and thus becomes unmovable while maintaining a required shear cutting angle with respect to the movable blade 19.

On the other hand, if the printer 100 (or the opening/closing unit 3) is configured to transition from the CLOSED state to the OPEN state, a reverse operation opposite to the operation described above is performed, in which the OPEN/CLOSED sensor detects the OPEN state of the opening/closing unit 3 and drives the cutter motor 20 so that the movable blade 19 moves from the start position to the retreat position.

When the print medium P is to be cut, the cutter motor 20 is driven to rotate the worm wheel 22. At this time, the stud 27 of the worm wheel 22 moves in the circumferential direction of the worm wheel 22 to transfer a driving force (from the cutter motor 20) to the cutter link 18 so that the movable blade 19 moves toward the fixed blade 15, i.e., toward the cutting position, while being in contact with the fixed blade 15. As the movable blade 19 moves down to the cutting position along the fixed blade 15, the movable blade 19 cuts the print medium in cooperation with the fixed blade 15. Upon reaching the cutting position, the movable blade 19 moves back to the start position.

As described above, according to this embodiment, the movable blade and the fixed blade are separately arranged in the opening/closing unit and the main body unit, respectively, which allows the print medium to be set into proper position for printing. In addition, according to this embodiment, when the opening/closing unit is placed in the OPEN state, the fixed blade and the movable blade are configured to move to the retreat positions, thereby preventing a user from making contact with the blades.

While certain embodiments have been described, these embodiments have been presented by way of example only, and are not intended to limit the scope of the inventions. Indeed, the novel mechanisms and apparatuses described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cutter mechanism comprising:
a fixed blade unit including a fixed blade, the fixed blade unit attached to a first portion of a printer, the printer having an OPEN state and a CLOSED state; and
a movable blade unit including a movable blade, the movable blade unit attached to a second portion of the printer, the second portion of the printer positioned such that a print medium conveyance path passes between the first portion and the second portion, the movable blade configured so that it moves along the fixed blade to cut a print medium, when the printer is in the CLOSED state, and when the printer is in an OPEN state, the fixed blade and the movable blade configured to move to a fixed blade OPEN state position and a movable blade OPEN state position, respectively away from the print medium conveyance path.

2. The cutter mechanism of claim 1, wherein the first portion of the printer is a main body unit and the second portion of the printer is an opening/closing unit.

3. The cutter mechanism of claim 1, wherein the fixed blade unit further comprises a fixed blade stay to which the fixed blade is attached, and an elastic biasing member configured to bias the fixed blade stay such that the fixed blade is movable to the fixed blade OPEN state position away from the print medium conveyance path.

4. The cutter mechanism of claim 1, wherein the movable blade unit further comprises a motor configured to drive the movement of the movable blade.

5. The cutter mechanism of claim 1, further comprising:
an OPEN/CLOSED sensor configured to detect when the printer is in the OPEN state; and
a movable blade position detecting sensor configured to detect a position of the movable blade,
wherein the movable blade moves to the movable blade OPEN state position when the OPEN/CLOSED sensor detects the printer is in the OPEN state.

6. The cutter mechanism of claim 5, wherein the fixed blade moves to the fixed blade OPEN state position when the printer is in the OPEN state.

7. A printer comprising:
a main body unit configured to rotatably hold a thermal head by means of a spring configured to bias the thermal head against a platen provided in a opening/closing unit configured to be rotatably fixed to the body unit;
a print medium conveyance path interposed between the thermal head and the platen;
a fixed blade unit configured to be attached to the main body unit, including a fixed blade, a fixed blade stay to which the fixed blade is attached, and an elastic biasing member configured to bias the fixed blade stay such that the fixed blade is movable to a fixed blade OPEN state position away from the print medium conveyance path; and
a movable blade unit with a movable blade, configured to be is attached to the opening/closing unit, the movable blade configured to cut a print medium in cooperation with the fixed blade, the fixed blade and the movable blade configured to move to the fixed blade OPEN state position and a movable blade OPEN state position, respectively, away from the print medium conveyance path when the opening/closing unit is in an OPEN state, and the fixed blade configured to be fixed to a position at which the movable blade is movable along the fixed blade to cut the print medium when the opening/closing unit is in a CLOSED state.

8. The printer of claim 7, further comprising an OPEN/CLOSED sensor configured to detect an opening/closing of the opening/closing unit, and a movable blade position detecting sensor configured to detect a position of the movable blade,
wherein the movable blade moves to the movable blade OPEN state position when the OPEN/CLOSED sensor detects the OPEN state of the opening/closing unit.

9. The printer of claim 8, wherein the fixed blade moves to the fixed blade OPEN state position when the opening/closing unit is in the OPEN state irrespective of the detection results from the OPEN/CLOSED sensor.

10. The printer of claim 7, wherein, in the CLOSED state, the movable blade is held at such a position that a space through which the print medium can pass is formed between the movable blade and the fixed blade.

11. A cutter mechanism configured to be used in a printer including a main body unit configured to hold a thermal head configured to be biased against a platen provided in a opening/closing unit configured to be rotatably fixed to the main body unit, and a print medium conveyance path interposed between the thermal head and the platen, the cutter mechanism comprising:
a fixed blade configured to be attached to one of the main body unit and the opening/closing unit; and
a movable blade configured to be attached to the other one of the main body unit and the opening/closing unit, the movable blade configured to cut a print medium in cooperation with the fixed blade, the fixed blade and the movable blade configured to move to a fixed blade OPEN state position and a movable blade OPEN state position, respectively, away from the print medium conveyance path when the opening/closing unit is in an OPEN state, and the fixed blade configured to be fixed to a position at which the movable blade is movable along the fixed blade to cut the print medium when the opening/closing unit is in a CLOSED state.

12. The cutter mechanism of claim 11, wherein the fixed blade unit is attached to the main body unit and the movable blade unit is attached to the opening/closing unit.

13. The cutter mechanism of claim 11, further comprising an elastic biasing member configured to bias the fixed blade such that the fixed blade is movable to the fixed blade OPEN state position away from the print medium conveyance path.

14. The cutter mechanism of claim 11, further comprising:
an OPEN/CLOSED sensor configured to detect an opening/closing of the opening/closing unit with respect to the main body unit; and
a movable blade position detecting sensor configured to detect a position of the movable blade,
wherein the movable blade moves to the movable blade OPEN state position when the OPEN/CLOSED sensor detects the OPEN state of the opening/closing unit.

15. The cutter mechanism of claim 14, wherein the fixed blade moves to the fixed blade OPEN state position when the opening/closing unit is in the OPEN state irrespective of the detection results from the OPEN/CLOSED sensor.
